(19) United States
(12) Patent Application Publication
(10) Pub. No.: US 2023/0155107 A1
(43) Pub. Date: May 18, 2023

(54) RETICULATED ELECTRODE STRUCTURE AND METHOD OF MAKING THE SAME

(71) Applicant: JONATHAN JAN, CULVER CITY, CA (US)

(72) Inventor: JONATHAN JAN, CULVER CITY, CA (US)

(21) Appl. No.: 17/693,924

(22) Filed: Mar. 14, 2022

Related U.S. Application Data
(60) Provisional application No. 63/279,879, filed on Nov. 16, 2021.

(51) Int. Cl. H01M 4/04

(52) U.S. Cl. CPC H01M 4/0485; H01M 4/0476

(57) ABSTRACT

A method of forming an electrode in an electrochemical battery. The method forms the electrode by sacrificial casting, wherein a reticulated foam is used to form a model of the electrode.

### RELATED APPLICATIONS

This patent application is related to U.S. Provisional Application No. 63/279,879 filed Nov. 16, 2021, entitled RETICULATED ELECTRODE STRUCTURE AND “METHOD OF MAKING THE SAME” in the name of the same inventor, and which is incorporated herein by reference in its entirety. The present patent application claims the benefit under 35 U.S.C § 119(e).

This patent application is further related to U.S. Pat. No. 10,079,382, issued Sep. 18, 2018, entitled “RETICULATED ELECTRODE STRUCTURE AND METHOD OF MAKING THE SAME” in the name of Alvin Snapper and Jonathan Jan, to U.S. Pat. No. 10,862,100, issued Dec. 8, 2020, entitled “RETICULATED ELECTRODE STRUCTURE AND METHOD OF MAKING THE SAME” in the name of Alvin Snapper and Jonathan Jan, and to U.S. Patent Application entitled “ELECTRICALLY CONDUCTIVE RETICULATED ELECTRODE STRUCTURE AND METHOD THEREFOR”, FILED Jun. 17, 2020, in the name of Jonathan Jan all of which are incorporated herein by reference in its entirety.

### TECHNICAL FIELD

The present application generally relates to an electrochemical battery, and more specifically, to a method of forming a reticulated electrode structure for an electrochemical battery that increases the reacting surface area thereby increasing the capacity and efficiency of the electrochemical battery, while reducing the weight and unusable metals of the battery.

### BACKGROUND

Electrochemical batteries generally include pairs of oppositely charged plates (positive and negative), and an intervening electrolyte to convey ions from one plate to the other when the circuit through the battery is completed. The ability of the electrochemical battery to deliver electrical current is generally a straight-line function of the surface area of the plates which is contacted by the electrolyte.

Metal electrode alkaline batteries generally have the highest energy densities among chemical batteries. Commercial applications may be limited to primary batteries. Primary batteries/cells may be defined as a battery that is designed to be used once and discarded, and not recharged with electricity and reused like a secondary battery/cell (i.e., rechargeable battery). In general, the electrochemical reaction occurring in the battery/cell is not reversible, rendering the cell unrechargeable. As a primary cell is used, chemical reactions in the battery use up the chemicals that generate the power. When the chemicals are gone, the battery stops producing electricity.

During chemical reactions in the battery, metal salts may be formed during the discharging cycles. The metal salts may be electrical insulators. The metal salts formed on the on the electrode surfaces inhibit reduction from the charging cycle. In the past, mercury may have been used to overcome this problem. However, mercury has been banned due to environmental hazards.

Most electrodes may be metal electrodes. The medal electrodes may be formed in shapes of rods, sheets, or grids. However, in most metal electrodes, only the surface layers may be used for chemical reactions. Most of the metal in the metal electrodes serve as architectural support which is a wasteful use of the material.

A flat plate constitutes a lower limit, which is frequently improved by sculpting the surface of the plate. For example, waffle shapes are known to have been used. However, there is a physical limitation to what can be done to “open-up” the surface of the plates, because the plates must resist substantial mechanical stringencies such as vibration and acceleration, and must be strongly supported at their edges. Thus, plates which are rendered delicate by casting or molding them into shapes which have thin sections are not a viable solution to increase the surface area of the plates. Further, such plates are subject to erosion and loss of material, thereby further reducing the strength of the plate over the life of the battery. A tempting solution is to use a woven screen for a plate. However, screens can be bent, usually on two axes. Especially after significant erosion they do not have sufficient structural strength. A battery is destroyed if a screen or plate collapses or contacts a neighboring screen/plate.

Despite the inherent potential structural disadvantages, it is a valid objective to attempt to increase the area exposed to the electrolyte by giving access to interior regions of a plate in order to increase the capacity and efficiency of the electrochemical battery. Otherwise the entire interior of the plate serves as no more than an electrical conductor and support for the surface of the plate. Holes through the plate can in fact increase surface area by the difference between their area removed from the surface and the added area of their walls. However, there is an obvious limitation to this approach.

A benefit in addition to increased surface area which could be obtained with an open-structured plate is the storage of electrolyte within the envelope of the plate. In turn, for a given amount of electrolyte volume, the gross volume of the battery can be reduced by the amount which is stored in the plates, rather than in the spacing between plates. Evidently the problem is one of increasing the surface area of the plates without compromising their strength.

Snaper, in U.S. Pat. No. 6,060,198 describes reticulated metal structures as plates for used as electrodes in the electrochemical battery. The reticulated structure consists of a plurality of pentagonally faced dodecahedrons. The reticulated metal structure is able to increase the capacity and efficiency of electrochemical batteries, while reducing the weight and unusable metals of the battery. However, the cost of making such metal forms maybe cost prohibitive for commercial production. Further, depositing metals on the reticulated polymer substrate is difficult. Vacuum plating, plasma deposition and other methods may only deposit thick coats of metal on the bearing surface. Thus, the metal may not be able to penetrate deep into the core of the substrate, thereby limiting the reacting surface area within the core of the substrate.

Therefore, it would be desirable to provide a system and method that overcomes the above. The system and method would allow the surface area throughout the substrate to be uniformly coated with conductive material.

### SUMMARY

In accordance with one embodiment, a method of forming an electrode in an electrochemical battery is disclosed. The method forms the electrode by sacrificial casting, wherein a reticulated foam is used to form a model of the electrode.

In accordance with one embodiment, a method of forming an electrode in an electrochemical battery is disclosed. The method comprises: forming a model of the electrode, wherein a reticulated foam is used to form the model of the electrode, the reticulated foam being an open cell reticulated polymer foam having tubes formed therein that are connected together allowing a liquid substance to flow through; covering the model with molecular sieves, wherein a portion of the molecular sieves are applied within the tubes of the open cell reticulated polymer foam; and mounting the model onto a tree structure having a metal delivery system to form the electrode by sacrificial casting.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a flowchart showing a method of forming the electrode, in accordance with an embodiment of the present invention

FIG. 2 is a front view of the electrode formed by the method of FIG. 1 depicting how the molecular sieves are evenly distributed on the surface of the metal electrode, in accordance with an embodiment of the present invention;

FIG. 3 is a magnified view of a single molecular sieve used in forming the electrode, in accordance with an embodiment of the present invention; and

FIG. 4 is a magnified view of the crystalline architecture of the self-assembled molecular sieve and its cavity in accordance with an embodiment of the present invention.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method disclose a reticulated electrode structure for use in an electrochemical battery. The reticulated electrode structure may be formed using a methodology that may increase the reacting surface space. By increasing the surface space of the reticulated electrode structure, one may increase the capacity and efficiency of the electrochemical battery. By increasing the surface space of the reticulated electrode structure, one may reduce the weight and unusable metals of the electrochemical battery. The reticulation electrode structure may allow for a minimum amount of metal to be used and may provide more space to hold electrolytes. Molecular sieves may be integrated on the surface of the metal electrode to increase the surface space of the reticulated electrode structure.

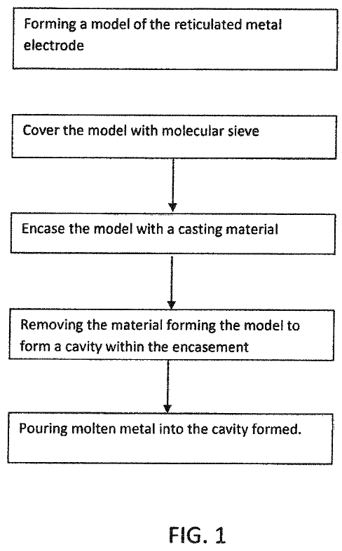

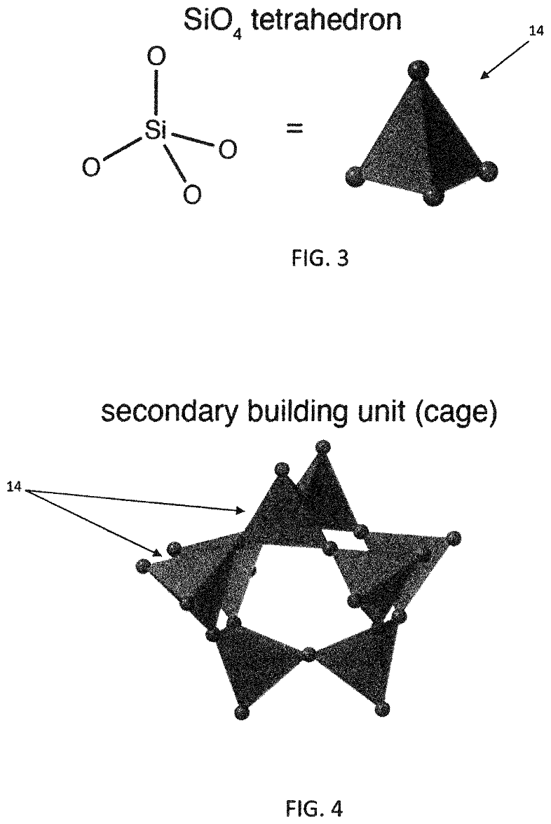

Referring to FIGS. 1-4, a method of forming a metal electrode structure 10 according to one embodiment of the present invention may be disclosed. The metal electrode structure 10 may be formed by sacrificial casting, or investment casting (hereinafter sacrificial casting). Sacrificial casting is a process wherein a model of a product is formed. The model may be formed in wax, clay or other material which may be burned/melted away. The model may be mounted onto a tree structure that may include a metal delivery system (gates and risers). The metal delivery system may also allow the material forming the model to be drained as may be disclosed below. In accordance with one embodiment, a reticulated foam material may be used to form the model. The reticulated foam may be a polyurethane foam. More specifically, the reticulated foam may be a ridged polyurethane foam. The reticulated polymer foams may be open celled. Open cell reticulated polymer foam may have air pockets or tubes formed therein that are connected together. The air pockets or tubes coupled together allow a liquid substance to flow through the entire structure, displacing the air.

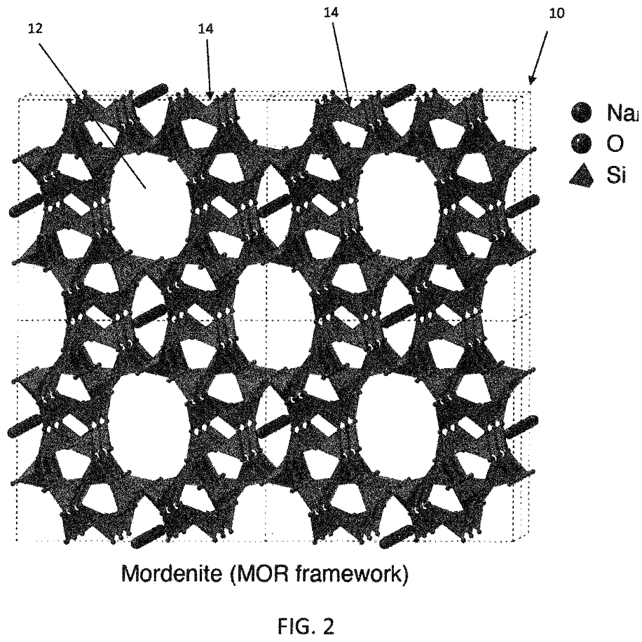

The model of the metal electrode 10 may take of different geometrical forms. The metal electrode 10 may be formed as reticulated electrodes, which may also be made in many forms: rectangular lattice, cylindrical, or tubular. FIG. 2 shows metal electrode 10 as a square. Every strand of the reticulation 12 is in the shape of a rod. Anode and cathode electrodes can be arranged crisscross to minimize the distance between the electrodes. Since the electrodes are anchored on both ends with lead wires (bridge), and the metal electrodes 10 may be covered by molecular sieve as disclosed below. Separators might not be necessary.

In accordance with one embodiment, when the model is formed, the model may be covered with molecular sieve (zeolite) 14. Molecular sieves 14 may be crystalline metal aluminosilicates having a three-dimensional interconnecting network of Si, Al, Ca, Na, and K tetrahedra. Natural water of hydration is removed from this network by heating to produce uniform cavities which selectively adsorb molecules of a specific size. Molecular sieve 14 may come in clusters with self/assembled “cells” like honeycomb. The crystalline are orderly and the cavities are micron size. It is used in chemical processing as catalysts and ionic exchange.

The tree structure may then be covered with a casting material. The casting material should be formed as to remove any bubbles within the casting material so that a proper mold showing details of the model may be formed. In accordance with one embodiment, the casting material may be a ceramic slurry or plaster. Once the tree structure may be covered with the casting material, the casting material may be allowed to sit and cure till the casting material hardens.

In accordance with another embodiment, the tree structure may be placed in a casting sandbox. The tree structure may be covered with a green sand mixture. The green sand mixture may be formed of gradient grain size materials. The granulated size of the green sand mixture may determine the surface condition of the casted item being formed. In accordance with one embodiment, the green sand mixture may be formed of: silica sand (SiO₂); chromite sand (FeCr₂O₄) or zircon sand (ZrSiO₄) mixed with a proportion of olivine, staurolite, or graphite; clay; water, inert sludge and anthracite.

The model may then be melted and drained from the casting material and/or green sand mixture. This may leave a cavity within the casting material/green sand mixture in the shape of the model. When the model is removed, the molecular sieve 14 may adhere to the interior walls forming the cavity. In accordance with one embodiment, the tree structure cover with the casting material/green sand mixture may be placed in a kiln/furnace for heating. The heat from the kiln/furnace may cause the material forming the model to melt and form a cavity within the casting material/green sand mixture in the shape of the model. The tree structure may be used to drain the melted material from the cavity formed in the casting material and/or green sand mixture. In the case of wax or other reusable materials, this melted material may be collected and reused.

Molten metal may then be poured into this cavity. In accordance with one embodiment, the cavity is filled with molten bronze. When the molten metal cools and solidifies, it retains the shape and dimensions of the model forming the metal electrode 10. The molecular sieve 14 is then bonded to the surface of the metal electrode 10. The metal electrode 10 may then be removed from the casting material/sandbox. After cleaning, the metal electrode 10 formed may have a thin layer of molecular sieve adhered thereto.

Casimir effect, also called Casimir-Lifshitz effect, is an effect arising from the quantum theory of electromagnetic radiation in which the energy present in empty space might produce a tiny force between two objects. The Casimir effect can be understood by the idea that the presence of macroscopic material interfaces, such as conducting metals and dielectrics, may alter the vacuum expectation value of the energy of the second-quantized electromagnetic field (as disclosed in E. L. Losada “Functional Approach to the Fermionic Casimir Effect Archived 31 May 2011 at the Wayback Machine” and Michael Bordag; Galina Leonidovna Klimchitskaya; Umar Mohideen (2009). “Chapter I; § 3: Field quantization and vacuum energy in the presence of boundaries”. Advances in the Casimir effect. Oxford University Press. pp. 33 ff. ISBN 978-0-19-923874-3. Reviewed in Lamoreaux, Steve K. (2010). “Advances in the Casimir Effect Advances in the Casimir Effect, M. Bordag, G. L. Klimchitskaya, U. Mohideen, and V. M. Mostepanenko Oxford U. Press, New York, 2009.$150.00 (749 pp.). ISBN 978-0-19-923874-3”. Physics Today.)

Thus, the Casimir effect may enable finite dimensional electric conductivity between the metal electrode and molecular sieve. Electrons can travel through the boundary layer. Battery efficiency is therefore improved.

Molecular sieve may come in clusters with self/assembled “cells” like honeycomb. The crystalline are orderly and the cavities are micron size. It is used in chemical processing as catalysts and ionic exchange. When used in chemical batteries, each cell is a reaction chamber with permeable encapsulation. Ions and electrons can move freely, but impurities and solid salts stay in the cavity without contaminating the electrolyte. Thus, a battery's internal resistivity is kept at minimum.

For the same space occupied, the metal electrode 10 formed in a reticulated architecture may have 4 times the surface area, comparing to solid metal electrode. The metal electrode 10 in a reticulated architecture is less than 20% of the weight of a solid metal electrode. That is substantial savings on weight, cost and materials. The molecular sieve further enhances the electrochemical efficiency and improves surge current on demand.

The foregoing description is illustrative of particular embodiments of the application, but is not meant to be a limitation upon the practice thereof. The following claims, including all equivalents thereof, are intended to define the scope of the application.

What is claimed is:

1. A method of forming an electrode in an electrochemical battery comprising:
forming the electrode by sacrificial casting, wherein a reticulated foam is used to form a model of the electrode.

2. The method of claim 1, wherein the reticulated foam is an open cell reticulated polymer foam.

3. The method of claim 1, comprising mounting the model onto a tree structure having a metal delivery system.

4. The method of claim 1, comprising covering the model with molecular sieves.

5. The method of claim 3, comprising:
covering the tree structure with a casting material; and
curing until the casting material hardens.

6. The method of claim 5, comprising:
placing the tree structure in a casting sandbox;
covering the tree structure with a green sand mixture;
melting and draining the model forming a cavity within the casting material; and
pouring motel metal into the cavity.

7. The method of claim 6, wherein the motel metal is motel bronze.

8. A method of forming an electrode in an electrochemical battery comprising:
forming a model of the electrode, wherein a reticulated foam is used to form the model of the electrode, the reticulated foam being an open cell reticulated polymer foam having tubes formed therein that are connected together allowing a liquid substance to flow through;
covering the model with molecular sieves, wherein a portion of the molecular sieves are applied within the tubes of the open cell reticulated polymer foam;
mounting the model onto a tree structure having a metal delivery system to form the electrode by sacrificial casting.

9. The method of claim 8, comprising.
covering the tree structure with a casting material; and
curing until the casting material hardens.

10. The method of claim 9, comprising:
placing the tree structure in a casting sandbox;
covering the tree structure with a green sand mixture;
melting and draining the model forming a cavity within the casting material, wherein the molecular sieves adhering to interior walls forming the cavity; and
pouring motel metal into the cavity.

11. The method of claim 10, wherein the motel metal is molten bronze.

12. The method of claim 10, comprising:
cooling the molten metal; and
removing the casting material.
